(19) United States
(12) Patent Application Publication
(10) Pub. No.: US 2026/0335794 A1
(43) Pub. Date: Oct. 29, 2026

(54) REFRIGERATOR APPLIANCE FILTER SMART FLUSH

(71) Applicant: Haier US Appliance Solutions, Inc., Wilmington, DE (US)

(72) Inventors: Haitian Hu, Louisville, KY (US); Steven Keith Root, Buckner, KY (US)

(21) Appl. No.: 19/187,337

(22) Filed: Apr. 23, 2025

(51) Int. Cl. B01D 35/143; F25D 23/12; F25D 29/00

(52) U.S. Cl. CPC B01D 35/143; F25D 23/12; F25D 29/005; F25D 2323/121

(57) ABSTRACT

A refrigerator appliance includes an ice maker appliance, a dispenser, a filter fluidly coupled to the dispenser, and a controller. A method of operating a refrigerator appliance includes the controller detecting a filter change operation of the refrigerator appliance, pausing an ice making operation of the ice maker appliance in response to the filter change operation, performing a smart flush operation of the filter, and activating the ice making operation in response to a termination of the smart flush operation.

### FIELD OF THE INVENTION

The present subject matter relates generally to refrigerator appliances, and more particularly to flushing filters within refrigerator appliances.

### BACKGROUND OF THE INVENTION

Refrigerator appliances generally include a cabinet that defines one or more chilled chambers for receipt of food articles for storage. Typically, one or more doors are rotatably hinged to the cabinet to permit selective access to food items stored in the chilled chamber. Further, refrigerator appliances commonly include an ice maker appliance mounted within an icebox on one of the doors or in a freezer compartment or fresh food compartment. To produce ice, liquid water is directed to the ice maker and frozen. For example, certain ice makers include an ice tray, for example, a mold body for receiving liquid water.

Refrigerator appliances generally include a filter for filtering the liquid water. Accordingly, refrigerator appliances generally provide filtered water to components such as the ice maker appliance. When changing the filter within the refrigerator appliance, a flush of the filter generally clears or removes carbon fines or air bubbles that have accumulated in the filter. In general, users can be unaware of the flushing step or forget to perform the flush after changing the filter, or can perform the flushing step unsatisfactorily, e.g., not completely flushing the filter. Missing the flushing step of changing a filter can lead to poor perceived performance of the refrigerator appliance and/or poorer quality of water or ice than a flushed filter.

Accordingly, a refrigerator appliance that obviates one or more of the above-mentioned drawbacks would be beneficial. Additionally, or alternatively, a method of operating a refrigerator appliance including a filter that overcomes one or more of the above-mentioned drawbacks would be beneficial and advantageous.

### BRIEF DESCRIPTION OF THE INVENTION

Aspects and advantages of the invention will be set forth in part in the following description, or may be obvious from the description, or may be learned through practice of the invention.

In one example embodiment, a method of operating a refrigerator appliance is provided. The refrigerator appliance includes an ice maker appliance, a dispenser, a filter fluidly coupled to the dispenser, and a controller. The method includes the controller detecting a filter change operation of the refrigerator appliance, pausing an ice making operation of the ice maker appliance in response to the filter change operation, performing a smart flush operation of the filter, and activating the ice making operation in response to a termination of the smart flush operation.

In another example embodiment, a refrigerator appliance is provided. The refrigerator appliance includes an ice maker appliance, a dispenser, a filter fluidly coupled to the dispenser, and a controller. The controller is configured to detect a filter change operation of the refrigerator appliance, pause an ice making operation of the ice maker appliance in response to the filter change operation, perform a smart flush operation of the filter, and activate the ice making operation in response to a termination of the smart flush operation.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a refrigerator appliance according to one or more example embodiments of the present subject matter.

FIG. 2 provides a perspective view of the example refrigerator appliance of FIG. 1, with the doors of the fresh food chamber shown in an open position.

FIG. 3 provides an interior perspective view of a refrigerator door of the example refrigerator appliance of FIG. 1.

FIG. 4 provides a schematic view of an embodiment of a water system for a refrigerator appliance according to example embodiments of the present subject matter.

FIG. 5 provides a schematic view of an embodiment of a water system for a refrigerator appliance according to example embodiments of the present subject matter.

FIG. 6 provides a schematic view of an embodiment of a water system for a refrigerator appliance according to example embodiments of the present subject matter.

FIG. 7 provides a schematic view of an embodiment of a water system for a refrigerator appliance according to example embodiments of the present subject matter.

FIG. 8 provides a schematic view of an embodiment of a water system for a refrigerator appliance according to example embodiments of the present subject matter.

FIG. 9 provides a schematic view of an embodiment of a water system for a refrigerator appliance according to example embodiments of the present subject matter.

FIG. 10 illustrates a flow chart of an example method of operating a refrigerator appliance according to example embodiments of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise, or counterclockwise, with the vertical direction V.

The word “example” is used herein to mean “serving as an example, instance, or illustration.” In addition, references to “an embodiment” or “one embodiment” does not necessarily refer to the same embodiment, although it may. Any implementation described herein as “example” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

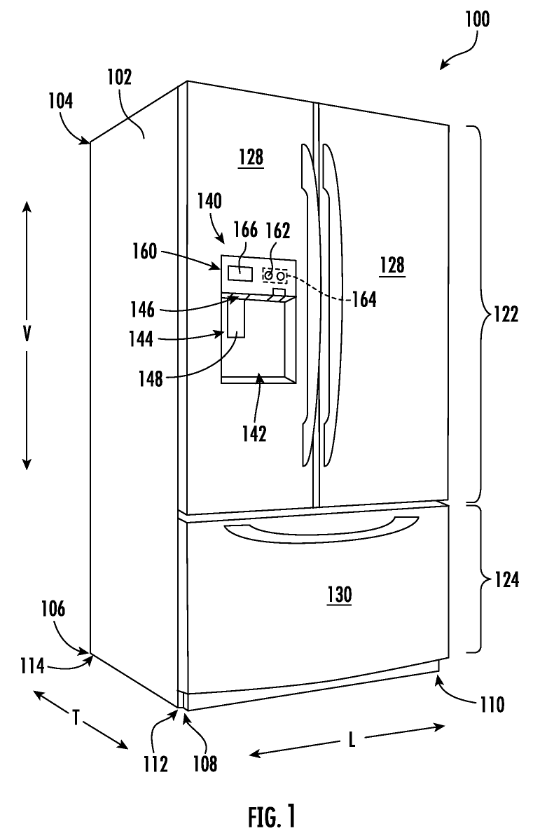

FIG. 1 provides a perspective view of an appliance 100 according to one or more example embodiments of the present subject matter. Appliance 100 may be configured as a refrigerator appliance or a standalone freezer appliance. Appliance 100 may define a vertical direction V, a lateral direction L, and a transverse direction T. Each of the vertical direction V, lateral direction L, and transverse direction T being mutually perpendicular to one another to form an orthogonal coordinate system. Appliance 100 may include a housing or a cabinet 102 that may extend between a top 104 and a bottom 106 along the vertical direction V, between a first side 108 and a second side 110 along the lateral direction L, and between a front side 112 and a rear side 114 along the transverse direction T.

Cabinet 102 may define one or more chilled chambers for receipt of food items for storage. In particular, cabinet 102 may define a fresh food chamber 122 positioned at or adjacent top 104 of cabinet 102 and a freezer chamber 124 arranged at or adjacent bottom 106 of cabinet 102. As such, appliance 100 may generally be referred to as a bottom mount refrigerator. It is recognized, however, that the benefits of the present disclosure apply to other types and styles of refrigerator appliances such as, e.g., a top mount refrigerator appliance, a side-by-side style refrigerator appliance, or a single door refrigerator appliance, or standalone freezer appliance. Consequently, the description set forth herein may be for illustrative purposes only and is not intended to be limiting in any aspect to any particular refrigerator chamber or freezer appliance configuration.

Appliance 100 may include refrigerator doors 128 that may be rotatably hinged to an edge of cabinet 102 for selectively accessing fresh food chamber 122. In addition, a freezer door 130 may be arranged below refrigerator doors 128 for selectively accessing freezer chamber 124. Freezer door 130 may be coupled to a freezer drawer (not shown) that may be slidably mounted within freezer chamber 124. Refrigerator doors 128 and freezer door 130 may be shown in the closed configuration in FIG. 1A. One skilled in the art will appreciate that other chamber and door configurations are possible and within the scope of the present invention.

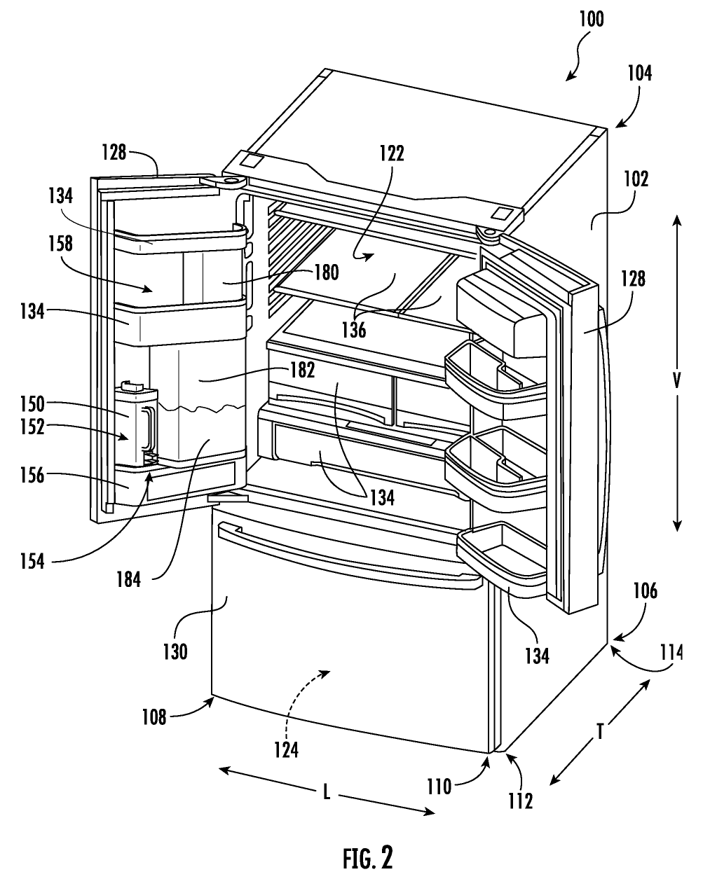

Referring now to FIG. 2, a perspective view of appliance 100 shown with refrigerator doors 128 in the open position is provided. As shown in FIG. 2, various storage components may be mounted within fresh food chamber 122 to facilitate storage of food items therein as will be understood by those skilled in the art. In particular, the storage components may include bins 134 and shelves 136. Each of these storage components are configured for receipt of food items (e.g., beverages or solid food items, etc.) and may assist with organizing such food items. As illustrated, bins 134 may be mounted on refrigerator doors 128 or may slide into a receiving space in fresh food chamber 122. It should be appreciated that the illustrated storage components are used only for the purpose of explanation and that other storage components may be used and may have different sizes, shapes, and configurations.

Referring now generally to FIG. 1, a dispensing assembly 140 may generally be configured for dispensing liquid water or ice bodies from an ice maker 180. Although an example dispensing assembly 140 may be illustrated and described herein, it should be appreciated that variations and modifications may be made to dispensing assembly 140 while remaining within the present subject matter.

Dispensing assembly 140 and its various components may be positioned at least in part within a dispenser recess 142 defined on one of refrigerator doors 128. In this regard, dispenser recess 142 is defined on front side 112 of appliance 100 such that a user may operate dispensing assembly 140 without opening refrigerator door 128. In addition, dispenser recess 142 may be positioned at a predetermined elevation convenient for a user to access ice and enabling the user to access ice without the need to bend-over. In the example embodiment, dispenser recess 142 may be positioned at a level that approximates the chest level of a user.

Dispensing assembly 140 may include an ice dispenser 144 that may include a discharging outlet 146 for discharging ice pieces from dispensing assembly 140. An actuating mechanism 148, shown as a paddle, may be mounted below discharging outlet 146 for operating ice dispenser 144 or water dispenser 154. Discharging outlet 146 and actuating mechanism 148 may be an external part of ice dispenser 144 and may be mounted in dispenser recess 142.

In alternative example embodiments, any suitable actuating mechanism may be used to operate ice dispenser 144. For example, ice dispenser 144 can include a sensor (such as an ultrasonic sensor) or a button rather than the paddle.

A control panel 160 may be provided for controlling the mode of operation. For example, control panel 160 may include one or more selector inputs 162, such as knobs, buttons, touchscreen interfaces, for selecting a desired mode of operation, for example an ice-dispensing button that may be provided for selecting crushed or non-crushed ice pieces. In addition, the one or more selector inputs 162 may be used to specify a fill volume or method of operating dispensing assembly 140. In this regard, the one or more selector inputs 162 may be in communication with a processing device or controller 164. Signals generated in controller 164 may operate appliance 100 and the dispensing assembly 140 in response to the one or more selector inputs 162. Additionally, a display 166, such as an indicator light or a screen, may be provided on control panel 160. Display 166 may be in communication with controller 164 and may display information in response to signals from controller 164.

As used herein, “processing device” or “controller” may refer to one or more microprocessors or semiconductor devices and is not restricted necessarily to a single element. The processing device can be programmed to operate appliance 100 and dispensing assembly 140. The processing device may include, or be associated with, one or more memory elements (e.g., non-transitory storage media). In some such embodiments, the memory elements include electrically erasable, programmable read only memory (EEPROM). Generally, the memory elements can store information accessible to the processing device, including instructions that can be executed by processing device. Optionally, the instructions can be software or any set of instructions or data that when executed by the processing device, cause the processing device to perform operations.

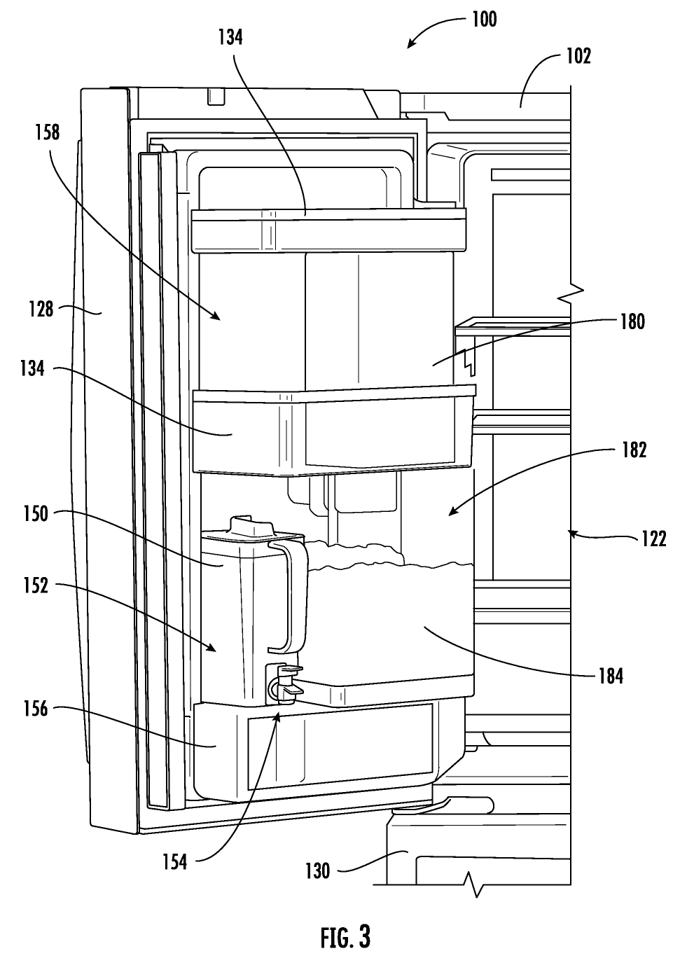

FIG. 3 provides an interior perspective view of an embodiment of one of the refrigerator doors 128. Appliance 100 includes an ice maker appliance 180, e.g., a first ice maker appliance. The ice maker 180 may be positioned at one or more of the refrigerator doors 128. In the illustrated example embodiment, ice maker 180 extends into fresh food chamber 122 when refrigerator door 128 is in the closed position. Chilled air from a sealed system (not depicted) of appliance 100 may be directed into components of the ice maker 180. Ice maker 180 may generally be configured for freezing liquid water to form ice pieces 184, for example, ice cubes or ice shapes, which may be collected and stored in ice storage bin 182 positioned below ice maker 180. In some embodiments, ice pieces 184 stored within ice storage bin 182 may be dispensed through discharging outlet 146 by dispensing assembly 140 (FIG. 1). Additionally or alternatively, the ice pieces may be stored in a separate ice storage box or compartment where they may be manually retrieved by a user. For instance, ice maker 180 may be configured to produce (e.g., freeze) designer or custom ice shapes (e.g., spheres, stars, geometric shapes, etc.) that may not be suitable for dispensation through dispensing assembly 140.

In some embodiments, the ice maker appliance 180 includes a nugget ice maker appliance configured to generate nuggets of ice, such as may include pockets of air in ice pieces, such as may be softer than conventional ice cubes at a freezer appliance. Nugget ice is provided from the ice maker appliance 180 to the ice storage bin 182 positioned in an above-freezing environment, such as at the fresh food chamber 122.

Appliance 100 may include a water-receiving appliance 150, such as a water reservoir and dispenser or a second ice maker appliance (e.g., for storing ice at freezer chamber 124). In some embodiments, water-receiving appliance 150 configured as a water reservoir and dispenser holding water 152 that may be dispensed through a dispenser 154, such as a faucet 154 (FIG. 3).

Various embodiments of the ice maker 180, ice storage bin 182, and water-receiving appliance 150 may be positioned at one or more bins 134 at the refrigerator door 128. In some embodiments, a water collection reservoir 156 may be positioned at the door 128, such as at bin 134, below the ice storage bin 182, the water-receiving appliance 150, or both. The water collection reservoir 156 may be positioned vertically below the ice storage bin 182, the water-receiving appliance 150, or both, such as to gravitationally receive water therefrom.

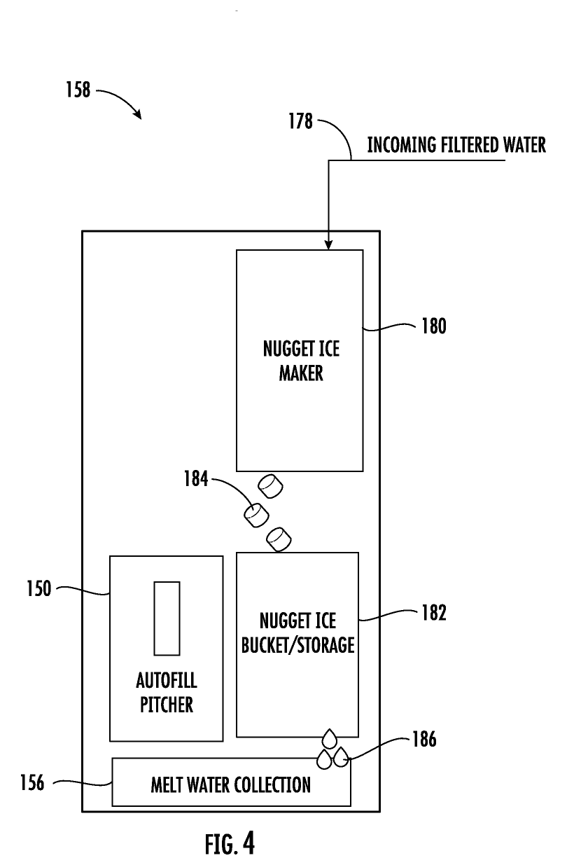

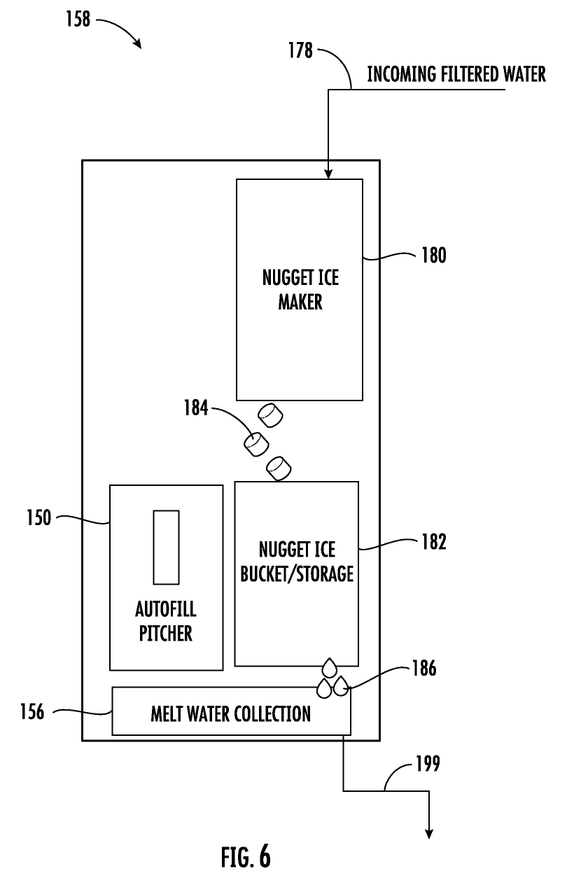

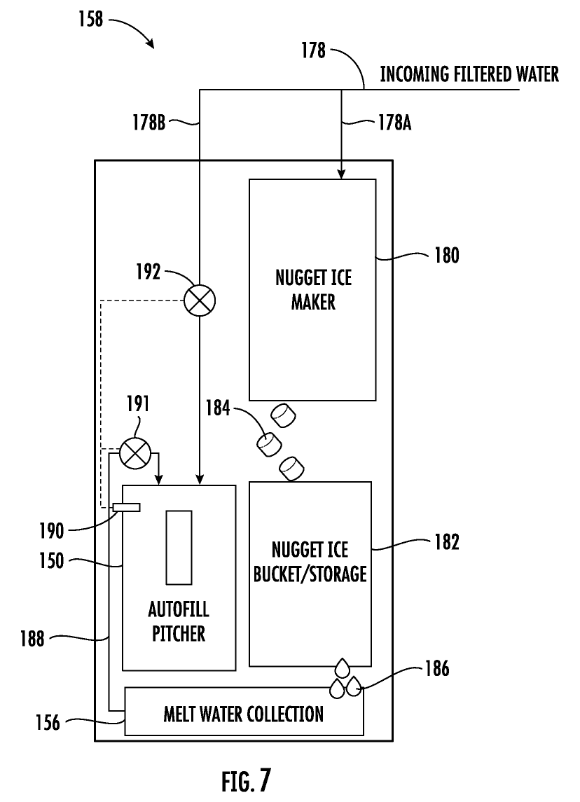

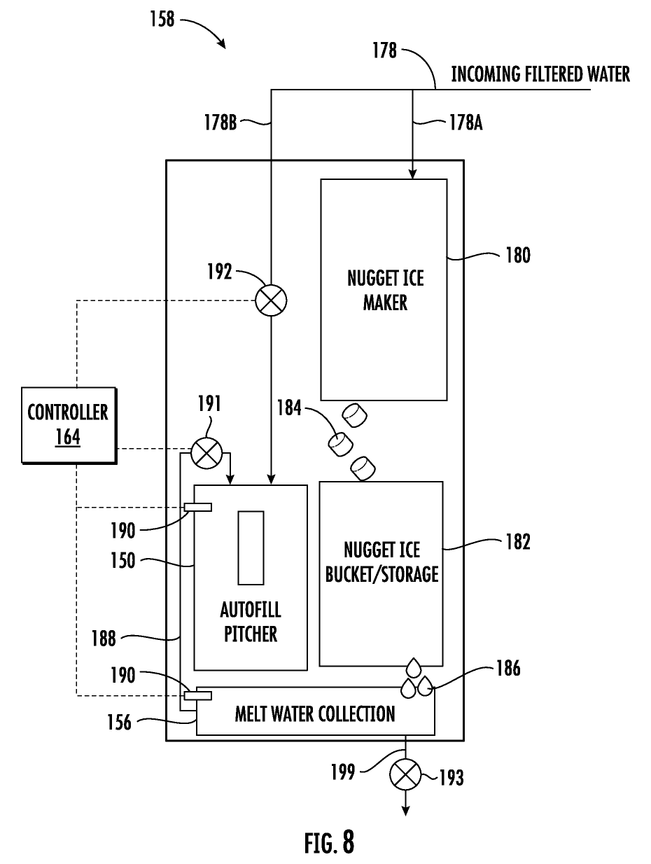

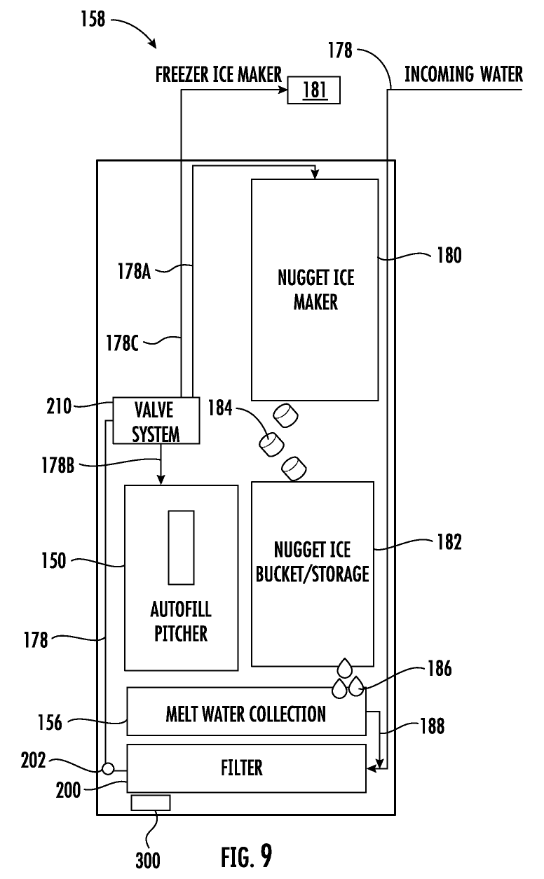

Referring now to FIGS. 4 through 9, schematic embodiments of a water system 158 are provided. Embodiments of the water system 158 include ice maker appliance 180, ice storage bin 182, water receiving appliance 150, and water collection reservoir 156. Embodiments of the water system 158 include a first water supply conduit 178 configured to supply water to the ice maker appliance 180. The ice storage bin 182 is positioned to receive ice 184 from the ice maker appliance 180. The water collection reservoir 156 forms a melt water collection bin positioned to receive melt water 186 from the ice storage bin 182. In general, the provided example embodiments illustrated in FIGS. 4 through 9 are not mutually exclusive, and the components of one example embodiment may be included in various combinations with one or more features of any one or more of the other example embodiments. For example, the drain conduit of FIG. 6 and the flow control devices 191, 192, 193 of FIG. 7 may be included in any other example embodiment, the controller 164 of FIG. 8 may be combined with features from any of the other embodiments, and the filter provided in FIG. 9 may be included in any of the other example embodiments.

Referring to FIG. 4, the water collection reservoir 156 forms a collection area below the ice storage bin 182 for collecting melt water 186 from the ice stored above freezing temperatures at the fresh food chamber 122. In various embodiments, the water collection reservoir 156 may include baffles (not shown) to minimize sloshing, waves, spills, or other disturbances as the door 128 is open and closed. The water collection reservoir 156, the ice storage bin 182, or both, may include openings, holes, or slots to direct melt water from the ice storage bin 182 to the water collection reservoir 156. Openings at the water collection reservoir 156, the ice storage bin 182, or both, are configured large enough to capture ice that falls when the ice storage bin 182 is removed.

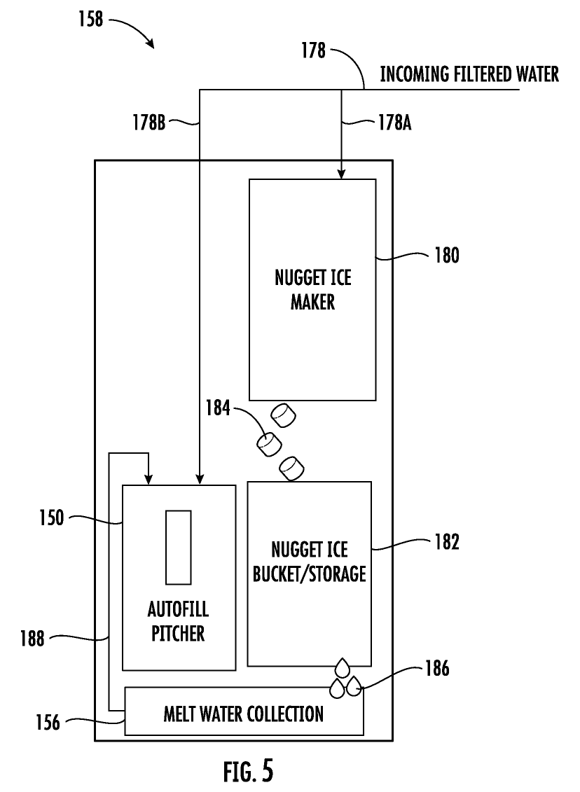

Referring to FIG. 5, in various embodiments, the water system 158 includes a return conduit 188 which is configured to supply melt water 186 from the water collection reservoir 156 to the water-receiving appliance 150. In an example embodiment of a method for recycling melt water at a refrigeration appliance, melt water 186 received at the water collection reservoir 156 may be flowed, pumped, or gravitationally fed from the water collection reservoir 156 to the water-receiving appliance 150.

Referring still to FIG. 5, in various embodiments, the first water supply conduit 178 includes a first supply conduit 178A configured to supply water to the ice maker 180, and a second supply conduit 178B configured to supply water to the water-receiving appliance 150. Water supply conduit 178, 178A, 178B may form main supply conduits configured to supply water from a main water source (e.g., a main water supply line at a residence or office). For example, an ice making operation of ice making appliance 180 may generally include ice making appliance 180 receiving water from water supply conduit 178, e.g., first supply conduit 178A, for freezing and turning into ice. Water supply conduit 178, 178A, 178B are provided by way of example only, and other configurations and conduits may be provided within the scope of the present disclosure.

In some embodiments, such as depicted in FIG. 6, a drain conduit 199 extends from the water collection reservoir 156. For example, drain conduit 199 may be configured to drain melt water from the water collection reservoir 156 via gravitational force. Water supplied from first water supply conduit 178 may contrast to water supplied from water collection reservoir 156 through return conduit 188 based at least on an amount of total dissolved solids (TDS) present in the main water supply (e.g., conduit 178) in contrast to melt water 186 from ice 184 at ice storage bin 182. As the presence and magnitude of TDS in water can change the taste, appearance, freezing point, or overall user experience with the water, amounts and ratios of water provided to the water-receiving appliance 150 as drinking water or as a second ice making appliance may be controlled to improve water or ice quality received by a user.

Referring now to FIG. 7, in various embodiments, a flow control device 191, 192 is configured to selectively limit supply of water from the second water supply conduit 178B and the return conduit 188 to the water-receiving appliance 150. The flow control device 191, 192 may be configured as an appropriate type of valve configured to selectively articulate to permit and inhibit flow of water to the water-receiving appliance 150.

In some embodiments, a water level sensor 190 is communicatively coupled to the flow control device 191, 192. The water level sensor 190 is configured to command selective articulation of the flow control device 191, 192 to permit flow of water from the second supply conduit 178B and the return conduit 188 to the water-receiving appliance 150. In some embodiments, the water level sensor 190 may be included at the water-receiving appliance 150, such as to command water fill at the water-receiving appliance 150. Additionally, or alternatively, the water level sensor 190 may be included at the water collection reservoir 156, such as to command drain or removal of water from the water collection reservoir 156.

Referring to FIG. 8, in some embodiments, the water level sensor 190 and flow control devices 191, 192, 193 are operably coupled to controller 164. Controller 164 is configured to receive signals from the water level sensor 190 and transmit control signals to the flow control devices 191, 192, 193 to selectively command and articulate opening and closing to permit and inhibit flow of water such as described herein. In some embodiments, drain conduit 199 may extend from the water collection reservoir 156, and a drain flow control device 193 may be positioned at the drain conduit 199 to selectively permit and inhibit flow of melt water through the drain conduit 199. In some example embodiments, a user may manually drain the water collection reservoir 156.

In an example embodiment of a method for recycling melt water at a refrigeration appliance, the water-receiving appliance 150 may generate a demand signal to receive or replenish water to the water-receiving appliance 150. For instance, the demand signal may be a signal generated and transmitted from the water level sensor 190. Controller 164 may be configured to provide a ratio of main water, through conduit 178B, to melt water, through conduit 188, such as to maintain TDS at or below a threshold at the water-receiving appliance 150. It should be appreciated that the ratio may be any appropriate ratio as may be determined by one skilled in the art, as may correspond to a desired taste, appearance, freezing point, or other quality of water at the water-receiving appliance 150.

In various embodiments, controller 164 may be configured to transmit a fill level signal from the water level sensor 190 to the drain flow control device 193. The fill level signal may correspond to a fill level (e.g., max fill level) at the water-receiving appliance 150. The fill level signal corresponding to a max fill level commands drain flow control device 193 to drain melt water from water collection reservoir 156, such as to inhibit flow of water from the water collection reservoir 156 to the water-receiving appliance 150.

Referring now to FIG. 9, a filter 200 and a valve system 210 may be provided with water system 158. Water system 158 may include first water supply conduit 178 configured to supply water to valve system 210 through filter 200, such as to supply filtered water to valve system 210. As described above, ice storage bin 182 may be positioned to receive ice 184 from the ice maker appliance 180, and water collection reservoir 156 may form a melt water collection bin positioned to receive melt water 186 from the ice storage bin 182. Return conduit 188 may generally fluidly couple back to first water supply conduit 178, such as to recirculate and/or refilter water from water collection reservoir 156. Accordingly, water within first water supply conduit 178 may be a combination of water from a main water source (e.g., a main water supply line at a residence or office) and water from water collection reservoir 156. In general, some example embodiments of water system 158 may include a pump 202 configured to urge water from water supply conduit 178 to dispensing assembly 140 or ice making appliance 180, e.g., through filter 200 and valve system 210 to the desired component. In other example embodiments, pump 202 may be omitted, and thus valve system 210 may control the flow of water through filter 200.

Valve system 210 may generally be operably coupled to controller 164, such that controller 164 receives and transmits signals operative of at least one of a plurality of flow control devices of valve system 210 to selectively permit and inhibit flow of water therethrough. In general, valve system 210 may receive water from first water supply conduit 178. In general, a filter 200 is fluidly coupled to valve system 210, e.g., filter 200 may be provided on first water supply conduit 178, whereby water flowing to valve system 210 is filtered through filter 200 before entering valve system 210.

In general, extending from valve system 210 may be a plurality of water supply conduits, e.g., as described above, water supply conduit 178B, e.g., a second water supply conduit 178B, may be fluidly coupled to valve system 210 and be configured to provide water to water-receiving appliance 150. In general, water supply conduit 178A, e.g., third water supply conduit 178A, may be fluidly coupled to valve system 210 and be configured to provide water to ice maker appliance 180. In general, water supply conduit 178C, e.g., fourth water supply conduit 178C, may be fluidly coupled to valve system 210 and be configured to provide water to second ice maker appliance 181.

In some example embodiments, valve system 210 may include flow meter (not shown). In general, the flow meter may be coupled in-line with filter 200 in order to monitor the amount of water flow from filter 200. Accordingly, controller 164 may make decisions based upon the measured flow amount from flow meter 214, such as calculating the amount of water flowed to the ice maker appliance 180 and/or the dispensing assembly 140.

As mentioned above, the present disclosure may also be applied to other types and styles of refrigerator appliances such as a top mount refrigerator appliance, a side-by-side style refrigerator appliance. Additionally, variations and modifications may be made to the ice maker and/or the dispenser while remaining within the scope of the present subject matter.

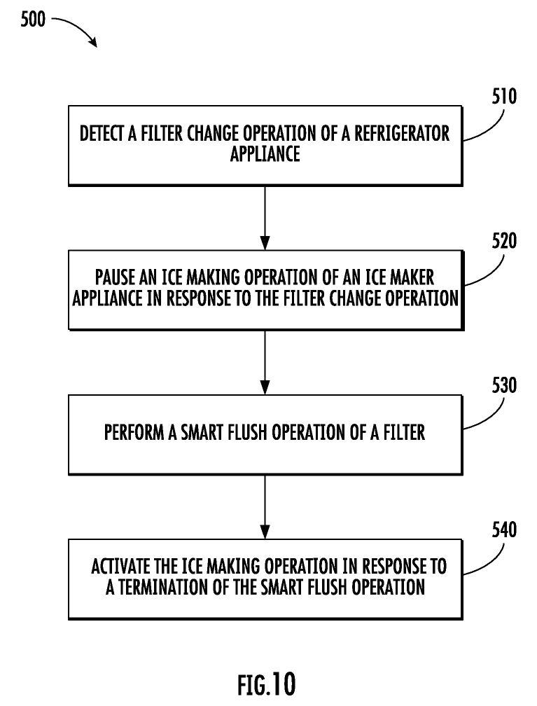

Now that the construction of refrigerator appliance 100 and the configuration of controller 164 according to example embodiments have been presented, an example method 500 (FIG. 10) of operating a refrigerator appliance will be described. Although the discussion below refers to the example method 500 of operating refrigerator appliance 100, one skilled in the art will appreciate that the example method 500 is applicable to the operation of a variety of other refrigerator appliances with various configurations. In some example embodiments, the various method steps as disclosed herein may be performed by controller 164 or a separate, dedicated controller.

Referring to FIG. 10, depicted are steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure.

As may be seen in FIG. 10, at (510), method 500 may generally include the controller detecting a filter change operation of the refrigerator appliance. In general, the filter change operation includes a user manually replacing filter 200 of refrigerator appliance 100, e.g., removing a used filter 200 from refrigerator appliance 100 and inserting a new filter 200 into refrigerator appliance 100. In some example embodiments, detecting the filter change operation may include receiving a signal indicative of the filter change operation, such as from a sensor 300 of refrigerator appliance 100. In general, sensor 300 may be any suitable sensor configured to provide a signal indicative of the filter change operation. In particular, sensor 300 may be a camera, e.g., configured to identify quick response codes, or other suitable scannable codes, such as barcodes, positioned on filter 200. In other example embodiment, sensor 300 may be a radio frequency reader generally configured to detect radio frequency identification tags, such as a tag placed on/in filter 200.

In general, controller 164 may be configured to provide a first notification in response to detecting the filter change operation. In particular, as described above display 166 of refrigerator appliance 100 may be in communication with controller 164 and may display information, such as notifications. For example, in response to detecting the filter change operation, controller 164 may provide a notification, such as via displaying informational text or illuminating an icon, on display 166 of refrigerator appliance 100 indicating that the filter 200 has been replaced and that a flushing operation should be performed.

At (520), method 500 may generally include pausing an ice making operation of the ice maker appliance in response to the filter change operation. As described above, ice making operation may generally include ice making appliance 180 receiving water from water supply conduit 178, e.g., first supply conduit 178A, for freezing and turning into ice. Accordingly, pausing the ice making operation may generally include temporarily inhibiting, preventing ice making appliance 180 from receiving water, e.g., temporarily stopping the ice making operation of ice making appliance 180 until the ice making operation is resumed as will be described below.

At (530), method 500 may generally include performing a smart flush operation of the filter. In general, a smart flush operation of the filter may include passing water through filter 200 in order to clear or remove carbon fines or air bubbles that have accumulated in filter 200, such as accumulated during manufacture of filter 200 or while filter 200 is stored before being used. In particular, the smart flush operation of filter 200 may include dispensing, from dispensing assembly 140, a volume of water, e.g., a specified quantity of water, and recording a fill time for the dispensing assembly 140 to dispense the specified quantity of water. In general, volume of water, e.g., the specified quantity of water, may generally be a quantity of water dispensed between four fluid ounces (4 fl. oz.) and twenty four fluid ounces (24 fl. oz.), such as between six fluid ounces (6 fl. oz.) and eighteen fluid ounces (18 fl. oz.), such as between eight fluid ounces (8 fl. oz.) and twelve fluid ounces (12 fl. oz.). Then, controller 164 may record the fill time for dispensing the specified quantity of water, e.g., recording the length of time between beginning the dispensing of the specified quantity of water and finishing the dispensing the specified quantity of water.

The smart flush operation of filter 200 also includes comparing the fill time to a predetermined range of fill times. The predetermined range of fill times may generally include a lower total fill time and an upper total fill time, e.g., a minimum fill time and a maximum fill time. For example, per dispensing four fluid ounces (4 fl. oz.) of water, a minimum expected fill time may include between one second (1s), and six seconds (6s), such as between two seconds (2s) and five seconds (5s), such as between three seconds (3s) and four seconds (4s) , such that the lower total fill time may be between one second (1s) and three seconds (3s). For example, dispensing twelve fluid ounces (12 fl. oz.) of water from dispensing assembly 140 may be expected to take between three seconds (3s) and eighteen seconds (18s), such as between six seconds (6s) and fifteen seconds (15s), such as between nine seconds (9s) and twelve seconds (12s), such that the lower total fill time may be between three seconds (3s) and nine seconds (9s).

In particular, the recorded fill time for dispensing the specified quantity of water may be compared to the predetermined range of fill times in order to determine when the filter 200 is satisfactorily flushed. In some example embodiments, the smart flush operation may be terminated in response to the fill time exceeding the upper total fill time, such as exceeding the maximum fill time, e.g., indicating filter 200 is satisfactorily flushed. In general, the upper total fill time may be provided, where when a total time spent flushing filter 200 reaches above the upper total fill time, the smart flush operation may be terminated. For example, the upper total fill time may be between twenty seconds (20s) and three hundred seconds (300s), such as between thirty seconds (30s) and two hundred seconds (200s), such as between forty seconds (40s) and one hundred seconds (100s). In another example embodiment, as will be explained below, the smart flush operation may be terminated in response to the recorded fill time being approximately equal to a subsequent recorded fill time.

In general, the smart flush operation may also include dispensing a second volume of water, e.g., where the second volume is the same specified quantity of water of the previous volume of water, and recording an updated fill time for the dispenser to dispense the second volume of water, e.g., recording the updated fill time in response to dispensing the specified quantity of water. For example, the smart flush operation may generally include dispensing the specified quantity of water one or more subsequent times and respectively recording an updated fill time for each subsequently dispensed specified quantity of water. For example, dispensing four fluid ounces (4 fl. oz.) of water may be recorded to have a fill time of five seconds (5s), and the subsequent dispensing of the four fluid ounces (4 fl. oz.) may be recorded to have an updated fill time of three seconds (3s). The smart flush operation may be terminated in response to a fill time being approximately equal to the updated or subsequent respective fill time. For example, continuing the above example, after recording the updated fill time of three seconds (3s), the subsequent dispensing of the four fluid ounces (4 fl. oz.) may be recorded to have an updated fill time of three seconds (3s), and as a result the smart flush operation is terminated.

At step (540), method 500 may generally include activating the ice making operation in response to a termination of the smart flush operation. For example, in response to the smart flush operation being terminated, the ice making operation may be resumed, where filtered water from filter 200 may be received by ice making appliance 180 for making ice. Additionally, controller 164 may be configured to provide a second notification in response to completion of the smart flush operation. In particular, as described above display 166 of refrigerator appliance 100 may display the second notification. For example, in response to completing, e.g., terminating, the smart flush operation, controller 164 may provide a second notification, such as via displaying informational text or un-illuminating an icon, on display 166 of refrigerator appliance 100 indicating that the filter 200 has been replaced and that a flushing operation should be performed.

As may be seen from the above, the method of operating a refrigerator appliance generally provides a method to verify successful flushing completion via a water dispense timing algorithm. Completion of the water dispense timing algorithm generally includes a flushing operation including filling approximately identical volumes of water, consistently, e.g., taking the same amount of time. When air is present, either in the conduit or when the new filter is being soaked (initially devoid of water), the flow of water may sputter, resulting in a longer fill time for the same water volume. As such, the water filling time will vary if air is present in the system. Users may continue flushing until the fill times stabilize, e.g., are approximately equal, or until a predetermined total flush time is reached, accounting for potential user errors such as inconsistent fill volumes. Another example of the flushing operation includes a user filling and emptying a vessel, such as a cup, a pitcher or a built-in water receiving appliance, or any combination of such vessels, until a total volume of water dispensed is detected by the algorithm.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a refrigerator appliance, the refrigerator appliance comprising an ice maker appliance, a dispenser, a filter fluidly coupled to the dispenser, and a controller, the method comprising:
detecting, by the controller, a filter change operation of the refrigerator appliance;
pausing, by the controller, an ice making operation of the ice maker appliance in response to the filter change operation;
performing, by the controller, a smart flush operation of the filter; and
activating, by the controller, the ice making operation in response to a termination of the smart flush operation.

2. The method of claim 1, wherein the smart flush operation comprises:
dispensing, from the dispenser, a volume of water, wherein the volume of water is a specified quantity of water;
recording, by the controller, a fill time for the dispenser to dispense the specified quantity of water; and
comparing, by the controller, the fill time to a predetermined range of fill times.

3. The method of claim 2, wherein the volume of water is a first volume of water, wherein the smart flush operation further comprises:
dispensing, by the controller, a second volume of water, wherein the second volume of water is the specified quantity of water dispensing the specified quantity of water;
recording, by the controller, an updated fill time for the dispenser to dispense the specified quantity of water in response to dispensing the second volume of water; and
terminating, by the controller, the smart flush operation in response to the fill time being approximately equal to the updated fill time.

4. The method of claim 2, wherein the range of fill times comprises a lower total fill time and an upper total fill time, the method further comprising comparing, by the controller, the recorded fill time to each of the lower total fill time and the upper total fill time.

5. The method of claim 4, further comprising terminating the smart flush operation in response to the fill time exceeding the upper total fill time.

6. The method of claim 1, wherein detecting the filter change operation comprises receiving, from a sensor of the refrigerator appliance, a signal indicative of the filter change operation.

7. The method of claim 6, wherein the sensor comprises one of a camera and a radio frequency reader.

8. The method of claim 1, further comprising providing, by the controller, a first notification in response to detecting the filter change operation.

9. The method of claim 8, further comprising providing, by the controller, a second notification in response to completion of the smart flush operation.

10. A refrigerator appliance, comprising:
an ice maker appliance;
a dispenser;
a filter fluidly coupled to the dispenser; and
a controller, the controller configured to:
detect a filter change operation of the refrigerator appliance;
pause an ice making operation of the ice maker appliance in response to the filter change operation;
perform a smart flush operation of the filter; and
activate the ice making operation in response to a termination of the smart flush operation.

11. The refrigerator appliance of claim 10, wherein during the smart flush operation, the controller is configured to:
dispense, from the dispenser, volume of water, wherein the volume of water is a specified quantity of water;
record a fill time for the dispenser to dispense the specified quantity of water; and
compare the fill time to a predetermined range of fill times.

12. The refrigerator appliance of claim 11, wherein the volume of water is a first volume of water, wherein during the smart flush operation the controller is further configured to:
dispense a second volume of water, wherein the second volume of water is the specified quantity of water;
record an updated fill time for the dispenser to dispense the specified quantity of water in response to dispensing the second volume of water; and
terminate the smart flush operation in response to the fill time being approximately equal to the updated fill time.

13. The refrigerator appliance of claim 11, wherein the range of fill times comprises a lower total fill time and an upper total fill time, and wherein the controller is configured to comparing the recorded fill time to each of the lower total fill time and the upper total fill time.

14. The refrigerator appliance of claim 13, wherein the controller is configured to terminate the smart flush operation in response to the recorded fill time exceeding the upper total fill time.

15. The refrigerator appliance of claim 10, wherein when detecting the filter change operation, the controller is configured to receive, from a sensor of the refrigerator appliance, a signal indicative of the filter change operation.

16. The refrigerator appliance of claim 15, wherein the sensor comprises one of a camera and a radio frequency reader.

17. The refrigerator appliance of claim 10, wherein the controller is configured to provide a first notification in response to detecting the filter change operation.

18. The refrigerator appliance of claim 17, wherein the controller is configured to provide a second notification in response to completion of the smart flush operation.
